(19) United States
(12) Patent Application Publication
(10) Pub. No.: US 2025/0196353 A1
(43) Pub. Date: Jun. 19, 2025

(54) METHOD AND APPARATUS FOR PROCESSING COMPONENTS OF A SPORTING ARTICLE BY MEANS OF A ROBOT

(71) Applicant: adidas AG, Herzogenaurach (DE)

(72) Inventors: Andre KERSCHBAUM, Gutenstetten (DE); Reyhan ADIEL, Erlangen (DE); Rainer OBERGRUSSBERGER, Burghausen (DE)

(21) Appl. No.: 18/978,855

(22) Filed: Dec. 12, 2024

(30) Foreign Application Priority Data
Dec. 13, 2023 (DE) 10 2023 134 930.9

(51) Int. Cl. B25J 9/16; A43D 119/00; B25J 11/00; B25J 13/08

(52) U.S. Cl. CPC B25J 9/1671; A43D 119/00; B25J 11/005; B25J 13/08

(57) ABSTRACT

The present disclosure relates to a method for processing a component for a sporting article, in particular a shoe sole, using a robot, the method comprising: (a.) creating a first path with respect to the component to be processed, comprising a list of points or a predetermined trajectory; (b.) determining a 3D scan of the component to be processed; (c.) calculating a global offset between the first path and the 3D scan of the component to be processed; (d.) calculating a plurality of local offsets between the first path and the 3D scan of the component to be processed; (e.) creating a second path based on the first path, the calculated global offset and the calculated plurality of local offsets; and (f.) transmitting the second path to the robot which performs the processing of the component based on the second path.

### CROSS REFERENCE TO RELATED APPLICATIONS

This application claims priority to German Patent Application No. 10 2023 134 930.9, filed Dec. 13, 2023, which is incorporated by reference herein in its entirety.

### TECHNICAL FIELD

The present disclosure relates to a method and an apparatus for processing a component of a sporting article, for example a shoe sole and/or an upper of a shoe, using a robot and a 3D scan of the component to be processed.

### BACKGROUND

The production of sporting articles, in particular shoe soles and/or an upper of a shoe, comprises a plurality of processing steps in which components of the sporting article are processed. Such processing steps can include deburring, cutting, decorating, grinding, or gluing of such components. Due to material instabilities of the components, which lead, inter alia, to shrinkage, distortion, curving or bending of the components, such processing steps are difficult to automate and are often carried out manually. The manual processing or post-processing causes higher production costs compared to automated methods and can lead to components not being processed in an ideal manner, which leads to faulty parts and in turn to an increase in costs.

Previous automated methods for processing components of sporting articles by means of a robot are based on the so-called “best-fit” principle. Firstly, a computer-aided design (CAD) model of the components is created. Furthermore, a processing path is created, along which the processing of the components is performed. This processing path can be taught to the system by means of learning techniques or can be explicitly predetermined, for example, by means of a sequence program. The predetermined path is then applied to the CAD model. In both cases, the path generally contains a list of points which are approached by a robot. Furthermore, a camera system is used which detects the position and orientation of the entire real components to be processed, for example by means of a scan. The data and information thus obtained are processed by the system and are used for calculating a global offset (offset) by matching the scan with the CAD model. This global offset can include both a translation and a rotation and allows the system to determine the location and the orientation of the components to be processed. The offset thus obtained is valid for the entire processing path of the robot and the processing path is corrected, for example rotated and/or displaced, in accordance with the global offset. This allows the system to correct a faulty position of the components as a whole.

However, deviations between real components and the CAD model, which are due to material instabilities of the components and can lead to shrinkage, distortion, curving, or bending of the components, cannot be corrected. Thus, the real components to be processed no longer correspond to the CAD model due to the material instabilities, even after a correction of a global offset between real components and CAD model. However, the robot continues to follow the ideal processing path related to the CAD model, and the robot movement actually carried out does not correspond to the optimal real processing path. This leads to non-accurately processed parts, which can reduce the quality of the end product. Depending on the magnitude of the deviation, the components can even be unusable after processing and must be excluded from further processing or must be post-processed manually. This leads to increased manufacturing costs, a higher working time per component and possibly a poorer quality of the components or the end product.

Therefore, an automated method for processing components that overcomes the problems identified above is needed.

### BRIEF SUMMARY

The present disclosure is directed to a method and an apparatus which enable the automation of the processing of components of a sporting article by the use of a robot. A global offset between a computer-generated model (for example, a 3D scan) of the component to be processed and the real component to be processed can be determined. A plurality of local offsets between the computer generated model of the component to be processed and the real component to be processed can be determined. Based on the global offset, the plurality of local offsets, and the real component to be processed, a path can be generated and transmitted to the robot to process the component. In this manner, the method and apparatus according to the present disclosure can reduce a deviation of the real component to be processed from the computer generated model, thereby increasing a quality of the component when processed by a robot.

A first embodiment (I) of the present disclosure is directed to a method for processing a component for a sporting article using a robot, the method comprising: creating a first path with respect to the component to be processed, comprising a list of points or a predetermined trajectory; determining a 3D scan of the component to be processed; calculating a global offset between the first path and the 3D scan of the component to be processed; calculating a plurality of local offsets between the first path and the 3D scan of the component to be processed; creating a second path based on the first path, the calculated global offset and the calculated plurality of local offsets; and transmitting the second path to the robot which performs the processing of the component based on the second path.

In a second embodiment (II), in the method according to the first embodiment (I), the first path is determined based on a CAD model of the component to be processed.

In a third embodiment (III), in the method according to any one of embodiments (I)-(II), the determining of the 3D scan is performed by an optical 3D scanner.

In a fourth embodiment (IV), in the method according to any one of embodiments (I)-(III), the calculating of the global offset is performed based on a feature of the component to be processed which can be detected by the optical 3D scanner.

In a fifth embodiment (V), in the method according to any one of embodiments (II)-(IV), the component to be processed is divided into a plurality of spatial sections using the CAD model on which the first path is based, and the calculating of the local offsets is performed with respect to the plurality of spatial sections of the component to be processed.

In a sixth embodiment (VI), in the method according to the fifth embodiment (V), the plurality of spatial sections are defined by cuboids.

In a seventh embodiment (VII), in the method according to any one of embodiments (I)-(VI), the first path and the second path comprise a plurality of spatial points.

In an eighth embodiment (VIII), in the method according to the seventh embodiment (VII), there is a bijective correspondence between the spatial points of the first path and the spatial points of the second path.

A ninth embodiment (IX) of the present disclosure is directed to an apparatus configured to perform the method according to any one of embodiments (I)-(VIII).

A tenth embodiment (X) of the present disclosure is directed to a tangible, non-transitory computer program comprising instructions which cause a computer to carry out the method according to any one of embodiments (I)-(VIII) when the computer program is executed on the computer.

### BRIEF DESCRIPTION OF THE FIGURES

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIG. 1 illustrates a flowchart of a method for processing a component, according to the some embodiments.

FIG. 2 illustrates a CAD model of a sole, a gripper, and a flange, and the first robot path created on the basis of the CAD model of the sole, according to some embodiments.

FIG. 3 illustrates a CAD model of a calibration adapter comprising a calibration flange, a calibration plate, and three calibration spheres which serve for the definition of a coordinate system, according to some embodiments,

FIG. 4 illustrates construction of a coordinate system using the three calibration spheres of FIG. 3, according to some embodiments.

FIG. 5 illustrates a CAD model of the calibration adapter and a 3D scan of the manufactured calibration adapter, and a transformation of the 3D scan data onto the calibration adapter, according to some embodiments.

FIG. 6 illustrates a region of an unambiguous feature of a sole, which is defined with respect to the CAD model, according to some embodiments.

FIG. 7 illustrates subdivision of the CAD model of a sole into 3D box regions, according to some embodiments.

FIG. 8 illustrates a first robot path created with respect to the CAD model and a second robot path defined based on local offsets, according to some embodiments.

FIG. 9 illustrates processing of a sole using a trimming tool, wherein the shoe sole is attached to a robot arm using a gripper.

FIG. 10 is a block diagram of a computer system for implementing various embodiments.

### DETAILED DESCRIPTION

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

The term “ideal” according to the present disclosure can refer to, but is not limited to, dimensions that perfectly match a design. For example, an “ideal component” can be a component that has dimensions that perfectly match a target dimension of the component as designed. More specifically, if a component has a dimension of, for example, 20 millimeters (mm) plus or minus 5 mm, the target dimension is 20 mm. Thus, an “ideal component,” in this example, has a dimension of 20 mm.

Only some possible embodiments of the disclosure are described in detail below. These embodiments can be modified and combined with one another in various ways, whenever they are compatible, and certain features can be omitted, insofar as they are dispensable.

Not all features of the described embodiments have to be present in order to realize the technical advantages of the present disclosure, which is defined by the subject matter of the claims and the overall disclosure. The disclosed embodiments can be modified by combining certain features of one embodiment with one or more features of another embodiment. In particular, the person skilled in the art will understand that features and/or functional elements of one embodiment can be combined with technically compatible features and/or functional elements of any other embodiment of the present disclosure.

In the present figures and the description, the same reference signs refer to the same elements. For reasons of clarity and conciseness, certain embodiments are presented without excessive detail if such details are implicit to the person skilled in the art in the light of the teachings contained herein and/or if such details would obscure the understanding of more relevant aspects of the embodiments.

To avoid redundancies, reference is also made to the explanations in the preceding sections, which also apply to the following detailed description. Furthermore, for the sake of brevity and clarity, not all features, parts, elements, aspects, components and/or steps are expressly identified by reference signs. This applies in particular if the person skilled in the art recognizes that such features, parts, elements, aspects, components and/or steps are present in a plurality.

As already stated, a method according to the disclosure or an apparatus according to the disclosure, as explained below with reference to some embodiments, can be used in particular for trimming or cutting shoe soles. However, the disclosure is not limited to the processing of shoe soles or components thereof.

The method according to the embodiments of the present disclosure can reduce the deviation of the real component to be processed of a sporting article from a computer-generated model, increases the individual adaptation of a path and thus optimizes the quality of the automatically processed component. Within the scope of the disclosure, a component of a sporting article can be understood to be a spatially delimitable section of the sporting article. The method can be used for the processing of a plurality of such components of a sporting article. In addition, a component according to the disclosure can also be understood to be the entire sporting article. This applies if the component cannot be subdivided into spatially delimitable sections. In some embodiments, the sporting article can be a shoe (for example, a sports shoe) and the component can be a sole or a part of a sole of the sports shoe. Furthermore, the component can also be an upper of the shoe.

For the individual adaptation of a path for processing a component of a sporting article, in some embodiments a first path can be created with respect to the component. This first path relates to an ideal component and can be given by a list of points or by a curve which the robot is intended to run through. The list of points or the curve can be defined with respect to the robot coordinate system and can serve as the starting point of the processing of the component, independently of the individual properties thereof.

In some embodiments, in the next step, a 3D scanner can be used for scanning or detecting the component to be processed. This can enable the recording of individual properties and features of the component to be processed, on which the individual adaptation of the second path can be based. These individual properties and features can comprise deviations from the ideal component and can comprise shrinkage, distortion, curving, bending or the like thereof.

In some embodiments, in the next step, a global offset between the first path and the 3D scan of the component to be processed can be calculated. This global offset can comprise a translation or rotation of the first path and can serve as a first adaptation of the path defined with respect to the ideal component and the real component.

In some embodiments, in the next step, a plurality of local offsets between the first path and the 3D scan of the component to be processed can be calculated. This can allow, in addition to the inclusion of global properties of the real component in the preceding method step, the inclusion of individual local properties. On the basis of these local offsets, a second path can be calculated, starting from the first path and the determined global offset, and the second path can take into account the local individual properties and features of the real component. This second path thus can reduce the deviation of the real component from the first path created with respect to the ideal component.

In some embodiments, in the last step, the second path can be transmitted to a robot or robot system. On the basis of this second path, the robot can perform the processing of the component previously detected by the 3D scan. The processing can comprise, for example, a cutting or trimming of the component, for example of the sole or a part of the sole. Furthermore, the processing can comprise polishing the component or applying adhesive to the component. Also, within the scope of the processing, decorative elements (for example, color layers) can be applied to the component.

In some embodiments, the first path can be determined based on a CAD (computer-aided design) model of the component to be processed. CAD offers the advantage that the component to be processed can be developed cost-effectively and quickly on a computer. If CAD data of the components to be processed are present, these can be directly incorporated into the method according to embodiments of the present disclosure. In this way, the CAD data can be used not only for the design of the component, but also for the production or processing thereof.

In some embodiments, the detecting or scanning of the component to be processed can be performed by an optical 3D scanner. This can enable a rapid imaging and a high degree of detailing.

In some embodiments, the calculation of the global offset can be performed based on a feature of the component to be processed, which can be detected by the 3D scanner. This feature can be component-dependent and can be, for example, a depression, elevation or bevel. The selection of the feature can depend on the degree of detailing of the 3D scanner used.

In some embodiments, the component to be processed can be divided into a plurality of spatial sections using the CAD model on which the first path is based, and the calculating of the local offsets can be performed with respect to the plurality of spatial sections of the component to be processed. In some embodiments, a higher number of spatial sections can lead to a higher number of local offsets and consequently to a more precise second robot path as compared to a second robot path created using a lower number of spatial sections.

In some embodiments, the plurality of spatial sections created with respect to the CAD model on which the first path is based can be cuboids. Cuboids can allow for a simple and unambiguous partitioning of the CAD model and thus of the first path (for example, cuboids are mathematically easy to handle and favor rapid numerical processing).

In some embodiments, the first path and the second path can have a plurality of spatial points. The plurality of spatial points can be used to generate a curvature of the component to be processed. For example, each spatial point of the plurality of spatial points can be connected to a previous spatial point and a subsequent spatial point along the respective path (for example, the first path or the second path) via lines to generate the curvature. As the number of spatial points increases, the accuracy of the curve can increase because a distance between each spatial point of the plurality of spatial points decreases.

In some embodiments, between the spatial points of the first path and the spatial points of the second path, there can be a bijective correspondence (for example, there can be a one-to-one assignment between points of the first path and the second path). Based on the bijective correspondence between the spatial points of the first path and the spatial points of the second path, the curvature of the component to be processed can also be taken into account in the second path. Furthermore, the bijective correspondence can limit the geometrical complexity of the second path and thus limit the running time of the robot with respect to the second path. Consequently, in some embodiments, creation of the first path can limit the running time of the robot before the creation of the second path.

Embodiments of the present disclosure are related to an apparatus configured to perform the method described herein. The various functions, features, embodiments and advantages of the method described herein can also apply to the apparatus configured to perform the method.

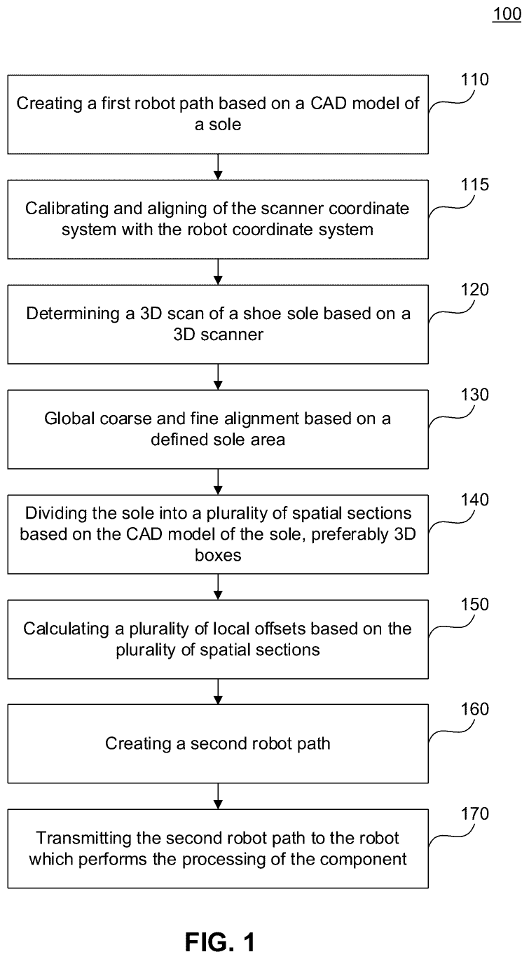

In some embodiments, a method 100 (shown in FIG. 1) for processing a component of a sporting article using a robot or robot system can comprise trimming of one or more expulsions of a shoe sole using a computer-controlled robot arm. Such expulsions on a component can be caused by the exit of material through openings or gaps, which can occur between two or more molded bodies. Such openings can be provided in order to vent a mold during molding or injection molding.

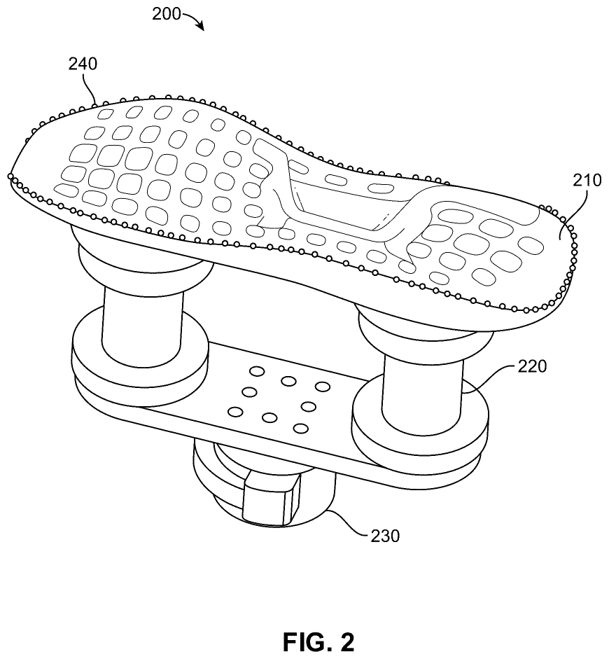

Shoe soles can be mass-produced articles and thus can be produced in large quantities. This can comprise the mass production of a specific sole model in a specific size. In some embodiments, in a first method step 110, a CAD model 200 (shown in FIG. 2) of an ideal sole 210 can be created, which serves as a reference model in the following steps. The CAD model 200 can reproduce the shape of an ideally shaped shoe sole (for example, the ideal sole 210). In some embodiments, the CAD model 200 can comprise a gripper 220 which can be mounted on a robot arm using a robot flange 230. The gripper 220 can attach to or receive the ideal sole 210 and thus can form a connection between the ideal sole 210 and the robot. In another embodiment, the created CAD model can consist of only one CAD model of the shoe sole. In some embodiments, the created CAD model can comprise only one CAD model of the shoe sole.

With respect to the CAD model 200 of the ideal sole 210, an ideal robot path 240 can be defined, which is either generated with the aid of learning techniques or is directly predetermined. The data associated with the ideal robot path 240 can be a list of points which can be defined with respect to the robot system and which define a trajectory which the robot is intended to follow. In some embodiments, the predetermined trajectory (for example, the ideal robot path 240) in the CAD model 200 of the ideal sole 210 comprising the gripper 220 corresponds exactly to the ideal sole 210. If this were not the case, deviations could occur in later method steps, such as when calculating a corrected trajectory. The number of points in the list of points can be calculated automatically as a function of the path curvature. The ideal robot path 240 can be generated as a polygon sequence of the points contained in the list of points. Alternatively or additionally, the ideal robot path 240 can also be generated based on the list of points using polynomial interpolation, spline interpolation, or another interpolation technique.

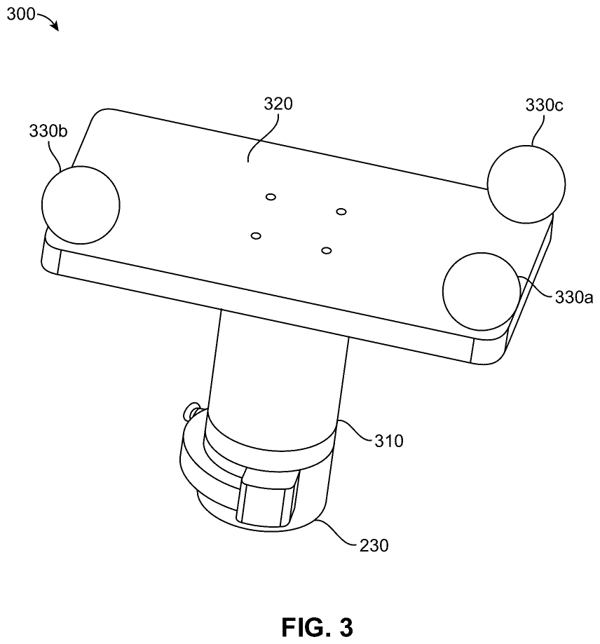

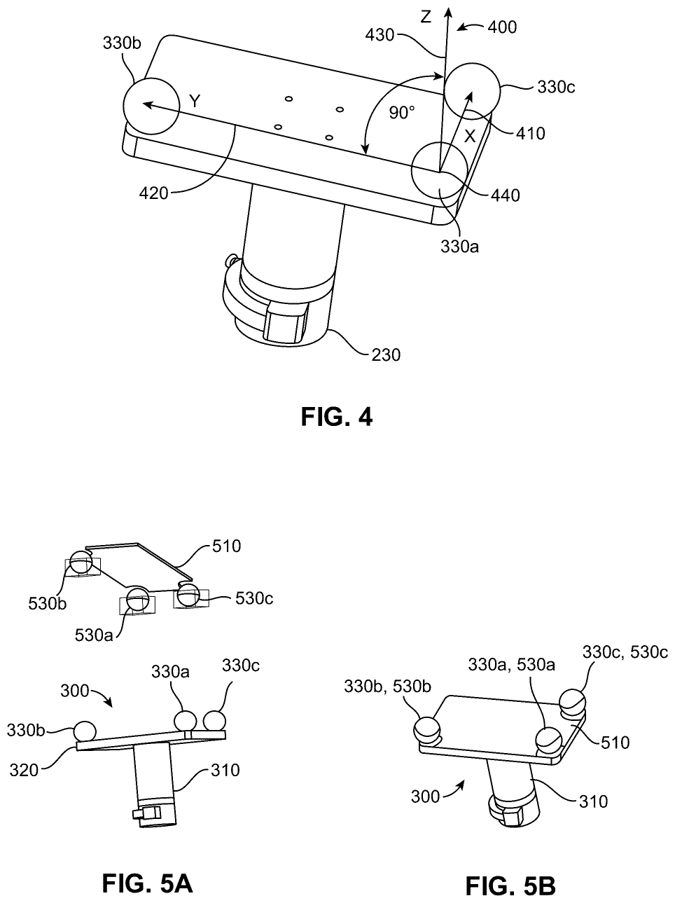

In some embodiments, in method step 115, a calibration phase can be executed. The calibration phase can align the coordinate system of the 3D scanner with the robot coordinate system. To execute the calibration phase, a calibration adapter 300 (shown in FIG. 3) was constructed as a CAD model and correspondingly manufactured. This calibration adapter 300 consists of a clamp flange 310, a calibration plate 320, and three optical calibration spheres 330a-330c. The three optical calibration spheres 330a-330c, which can be attached to the calibration plate 320, can define a coordinate system 400 (shown in FIG. 4) which can be traced back to the robot flange 230, i.e., the connecting element of robot arm and calibration adapter 300 or gripper 220, and thus to the origin of the robot coordinate system. This coordinate system 400 can be defined by a vector X 410 and a vector Y 420, which are defined by the centers of the calibration spheres 330a and 330c, respectively (for the vector X 410) or 330a and 330b, respectively (for the vector Y 420). The vector X 410 and the vector Y 420 have the same origin 440, namely the center of the sphere 330a, and thus define a plane in three-dimensional space. A third vector Z 430 can be perpendicular to the plane defined by the vector X 410 and the vector Y 420, and likewise has the center of the sphere 330a as its base point.

In some embodiments, the calibration phase can be optional and does not have to be performed every time a component is processed. In some embodiments, it would be sufficient, for example, to perform the calibration only once during the setup of the system or at specific time intervals. Therefore, the calibration phase of method step 115 is explained here for the sake of completeness.

In some embodiments, during the calibration phase, the calibration adapter 300 can be optically detected using the 3D scanner. In some embodiments, the calibration adapter 300 can be presented to the 3D scanner at the same spatial position and orientation as the sole mounted on the gripper 220, which will subsequently be processed. Through this optical detection of the calibration adapter 300, the centers of the calibration spheres 330a-330c and the calibration plate 320 can be recognized. Based on the CAD model of the calibration adapter 300 and the nominal positions of the centers of the calibration spheres 330a-330c relative to the robot flange 230, a transformation matrix can then be calculated by a computer system. In some embodiments, the transformation matrix can allow the position and orientation of the robot flange 230 relative to the 3D scanner to be calculated. The transformation matrix obtained can be stored on the computer system for future calculations.

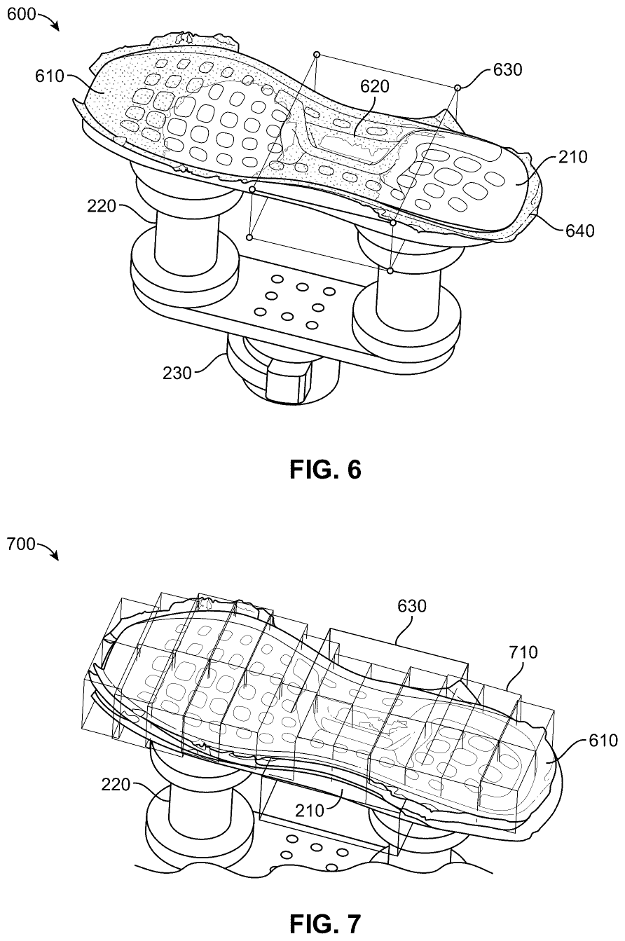

FIG. 5 illustrates an optical 3D scan 510 of the calibration adapter 300 from the view of the 3D scanner, and the CAD model of the calibration adapter 300. FIG. 5A shows the optical 3D scan 510 of the calibration adapter separate from the CAD model of the calibration adapter 300. FIG. 5B shows the optical scan 510 of the calibration adapter aligned with the CAD model of the calibration adapter 300. In some embodiments, the optical scan 510 can be aligned with the calibration adapter 300 by aligning the scanned calibration spheres (shown in FIGS. 5A-5B as spheres 530a-530c) with the CAD model of the calibration spheres 330a-330c. In some embodiments, a transformation matrix can be calculated based on identification of the centers of the calibration spheres 330a-330c and the calibration plate 320, so that the optical 3D scan 510 of the calibration adapter 300 can be aligned with the CAD model of the calibration adapter 300. In a further method step, which is performed after the calibration, the generation and storage of the transformation matrix, the CAD model of the calibration adapter 300 can be replaced by the CAD model of the gripper 220 which can be attached to the robot flange 230 (each of which are shown in FIG. 2). The sole 610 (shown in FIG. 6) to be processed can be mounted or placed on the gripper 220. In some embodiments, the robot arm or the robot flange 230 can already be in the initial position (for example, the position in which the calibration scan has been carried out), or can move to this position after the sole 610 has been mounted or placed on the gripper 220. Thereafter, in some embodiments, the determining 120 of a 3D scan 600 of the sole 610 can be performed by an optical 3D scanner.

In some embodiments, and as shown in FIG. 6, due to expulsion regions 640 (for example, regions of extra, unwanted material extending from the sole 610), which can arise during the production of the sole 610, and due to material instabilities (for example, stretching, shrinking, surface imperfections, etc.), the shape and/or size of the sole 610 does not correspond exactly to the shape and/or size of the ideal sole 210. In particular, the 3D scan 600 of the sole 610 can deviate from the ideal sole 210 stored in the CAD model 200.

In some embodiments, in a method step 130, a global pre-orientation of the CAD model 200 of the ideal sole 210 comprising the gripper 220 and the 3D scan 600 obtained of the sole 610 mounted on the gripper 220 can occur. The global pre-orientation can be used to register the scan data for the CAD model 200. In some embodiments, for purposes of identifying the sole 610 to be processed, the sole 610 can be assigned an unambiguous feature 620 which can be detected by the 3D scanner and which can be associated with a region 630. In some embodiments, more than one unambiguous feature 620 can be associated with the region 630. In the embodiment illustrated in FIG. 6, the unambiguous feature 620 can be a depression in the region 630 around a center of the sole 610. In some embodiments, a rough orientation can occur between a 3D scan 600 (shown in FIG. 6) of the sole 610 and the CAD model 200, based on the selected region 630 which contains the unambiguous feature 620. In some embodiments, the data of the 3D scan 600 of the sole 610 and of the CAD model 200 can be generated as point clouds (for example, a point cloud associated with the data of the 3D scan 600 and a point cloud associated with the CAD model 200). A transformation can be calculated which

minimizes the distance between the two point clouds in a global sense. Minimizing the distance between the two point clouds can comprise, for example, minimizing a distance metric between the point clouds with respect to the set of all transformation matrices. The result of this rough orientation is thus a transformation matrix.

In some embodiments, a global fine orientation (also referred to as an iterative closest point registration algorithm, or ICP registration) can occur, which can optimize the transformation determined during the rough orientation. The global fine orientation can further improve the global fine orientation of the 3D scan 600 of the sole 610 with respect to the CAD model 200.

In some embodiments, after the global fine orientation of the 3D scan 600 of the sole 610 and of the CAD model 200 (and thus a global orientation of an ideal robot path with respect to the 3D scan 600 of the sole 610), a local correction can occur in method step 140. The local correction can provide a precise orientation between the 3D scan 600 and the CAD model 200, which can go beyond mere translation or rotation of the models as a whole.

In some embodiments, for the local correction in the method step 140, the sole 610 can be subdivided into spatial sections 710 (shown in FIG. 7) along the sole 610 using a CAD model 700 generated from the 3D scan 600. For example, the spatial sections 710 can be generated by dividing the sole 610 along one or more longitudinal axes and one or more transverse axes. This can result in a subdivision of the sole 610 into spatial sections 710 that have a cuboid shape. In some embodiments, the spatial sections 710 can also be referred to below as 3D boxes 710. In some embodiments, the size of each of the respective 3D boxes 710 can be individually adjusted. In some embodiments, the size of each of the respective 3D boxes 710 can be the same for all 3D boxes 710. In some embodiments, the data from the 3D scan 600 of the sole 610 can be assigned to the spatial sections 710 and the scan data can be extracted from the point clouds with respect to the spatial sections 710.

In some embodiments, in a method step 150, the scan data defined with respect to the spatial sections 710 can be registered again against the CAD model 200 of the ideal sole 210 in the regions defined with respect to the spatial sections 710. In some embodiments, registering the spatial sections 710 can be accomplished by projecting the regions within the spatial sections 710 onto the CAD model 200 of the ideal sole 210 by area mapping, in which a three-dimensional object is projected on to a two-dimensional space. For example, a local compensation plane can be generated both in the CAD model 200 and in the 3D scan 600 of the sole 610 within each 3D box 710. These two compensation planes, determined separately for each 3D box 710, can be projected onto one another via the center of gravity of each of the compensation planes. This projection can result in a local transformation matrix for each 3D box 710.

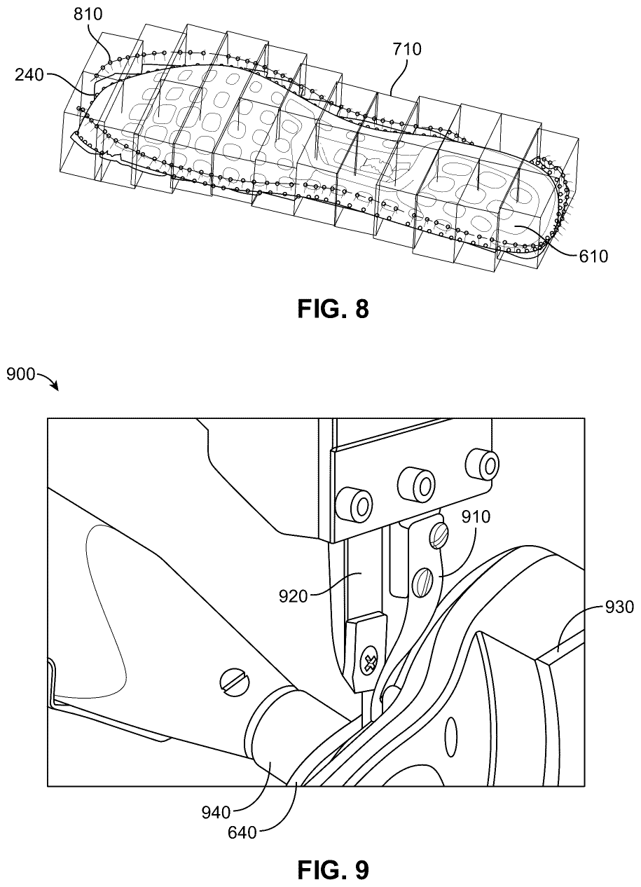

In some embodiments, the local correction of the robot path (based on the local transformation matrix for each 3D box 710) allows the robot to react locally to deviations in each 3D box 710 and to correct the robot path locally. These local corrections can provide a more precise adaptation of the 3D scan 600 of the sole 610 and of the CAD model 200 and thus provide a more precise adaptation of the ideal robot path 240 (shown in FIG. 2 and FIG. 8), which is defined with respect to the CAD model 200, to the individual properties of the sole 610. In some embodiments, a more precise ideal robot path 240 can lead to more precise trimming of the expulsion regions 640, whereby the quality of the trimmed sole 610 is increased as compared to a sole that is not trimmed using the method 100. Thus, the method 100 disclosed can allow for the automation of the trimming of expulsion regions 640 in shoe soles and lead to a reduction of working costs and an improvement of the product quality.

In some embodiments, after the determining of the local transformations, in method step 160, the path points of the ideal robot path 240 of the CAD model 200 are transformed back onto the 3D scan 600 of the sole 610 (as shown in FIG. 8). For this back transformation, the 3D boxes 710 can be used so that the affected path points can be determined for each subsection. For each 3D box 710, the path points can be transformed back onto the calibrated data of the 3D scanner. This transformation can supply a list of corrected path points 810 and thus a corrected robot path based on the corrected path points 810.

In some embodiments the calculated transformed path points (for example, the corrected path points 810) comprising the corrected robot path are stored including the global fine orientation. In method step 170, these data can be sent to the robot or to the robot system. Based on the data sent to the robot, a sole 930 (shown in FIG. 9) can be gripped by the gripper 220 around a trimming tool 900 that is immovable with respect to the robot. In some embodiments, the sole 930 can be guided along a stop 940. The stop 940 can form a counter piece against which an oscillating knife 920 runs, which separates the expulsion regions 640 from the sole 930. In some embodiments, a holding-down device 910 can bring the expulsion regions 640 into the correct position for removal (for example, the holding-down device 910 can cause the expulsion regions 640 to protrude upward).

In some embodiments, the sole 930 can be attached to a position immovable with respect to the robot arm and the robot arm can guide the trimming tool 900 for processing the sole 930 around the sole 930.

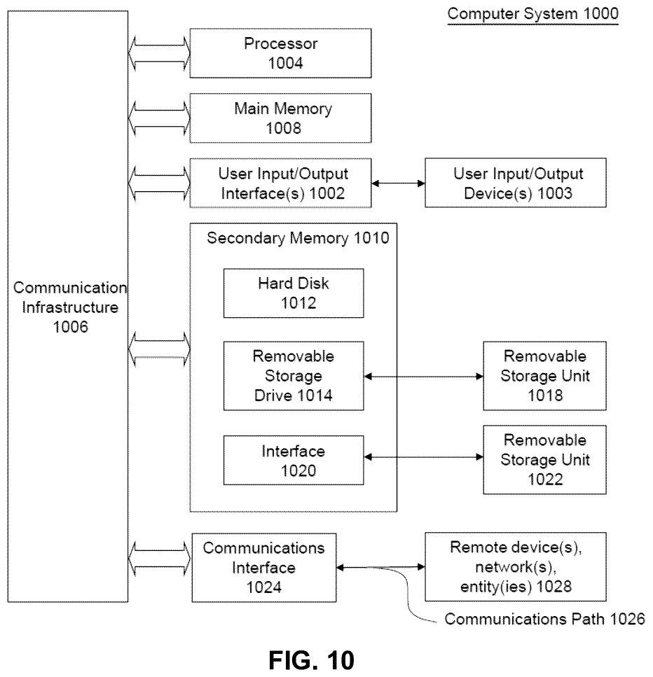

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof.

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/or any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to carry out the methods described herein.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

What is claimed is:

1. A method for processing a component for a sporting article using a robot, the method comprising:
(a) creating a first path with respect to the component to be processed, comprising a list of points or a predetermined trajectory;
(b) determining a 3D scan of the component to be processed;
(c) calculating a global offset between the first path and the 3D scan of the component to be processed;
(d) calculating a plurality of local offsets between the first path and the 3D scan of the component to be processed;
(e) creating a second path based on the first path, the calculated global offset and the calculated plurality of local offsets; and
(f) transmitting the second path to the robot which performs the processing of the component based on the second path.

2. The method according to claim 1, wherein the first path is determined based on a CAD model of the component to be processed.

3. The method according claim 1, wherein the determining of the 3D scan is performed by an optical 3D scanner.

4. The method according to claim 1, wherein the calculating of the global offset is performed based on a feature of the component to be processed which is detected by an optical 3D scanner.

5. The method according to claim 2, wherein the component to be processed is divided into a plurality of spatial sections using the CAD model on which the first path is based, and the calculating of the local offsets is performed with respect to the plurality of spatial sections of the component to be processed.

6. The method according to claim 5, wherein the plurality of spatial sections are defined by cuboids.

7. The method according to claim 1, wherein the first path and the second path comprise a plurality of spatial points.

8. The method according to claim 7, wherein there is a bijective correspondence between the spatial points of the first path and the spatial points of the second path.

9. An apparatus configured to perform the method according claim 1.

10. A tangible, non-transitory computer program comprising instructions which cause a computer to carry out the method according to claim 1 when the computer program is executed on the computer.
